(19) United States
(12) Patent Application Publication
(10) Pub. No.: US 2009/0154306 A1
(43) Pub. Date: Jun. 18, 2009

(54) OPTIMIZING FOCUS CROSSTALK CANCELLING

(75) Inventor: Johannes Leopoldus Bakx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/302,296

(22) PCT Filed: May 29, 2007
(86) PCT No.: PCT/IB2007/052007

§ 371 Date: Nov. 25, 2008

(30) Foreign Application Priority Data
Jun. 1, 2006 (EP) 06114854.0

(51) Int. Cl. G11B 7/00

(52) U.S. Cl. 369/44.14; G9B/7

(57) ABSTRACT

A device is arranged for scanning an optical record carrier (11), which has a data layer with parallel data tracks. The device has an optical head (22) comprising a detector having sub-detectors (44) for generating a main focus signal and sub-detectors (43,45) for generating satellite signals. A focus control unit (32) provides a focus actuator signal (38) to a focus actuator (34) in dependence of a focus error signal. A combining unit (41) generates the focus error signal based on the main focus signal and satellite signals in dependence on weight factors (Ga,Gb) for adjusting a correction of the main focus signal by the satellite signals. A servo filter (42) generates the focus actuator signal based on the focus error signal. A setting unit (40) sets the weight factors in dependence of an adjustment signal, which is based on the focus actuator signal (38). Advantageously the dissipation in the actuator is reduced, instead of minimizing residual focus error signals at the cost of large focus actuator dissipation.

The invention relates device for scanning an optical record carrier, the record carrier comprising a data layer having substantially parallel data tracks, the device comprising an optical head comprising a detector for receiving radiation reflected from the data layer, the detector having main sub-detectors for detecting a main focus signal from a main spot and satellite sub-detectors for detecting a satellite signal from a satellite spot, focus control means for providing a focus actuator signal to a focus actuator in dependence of a focus error signal, the focus control means comprising combining means for generating the focus error signal based on the main focus signal and the satellite signal in dependence on a weight factor for adjusting a correction of the main focus signal by the satellite signal, filtering means coupled to the focus error signal for generating the focus actuator signal, and setting means for setting the weight factor in dependence of an adjustment signal.

The invention further relates to a method of setting a weight factor in a device for scanning an optical record carrier, the record carrier comprising a data layer having substantially parallel data tracks, the device comprising an optical head comprising a detector for receiving radiation reflected from the data layer, the detector having main sub-detectors for detecting a main focus signal from a main spot and satellite sub-detectors for detecting a satellite signal from a satellite spot, focus control means for providing a focus actuator signal to a focus actuator in dependence of a focus error signal, the focus control means comprising combining means for generating the focus error signal based on the main focus signal and the satellite signal in dependence on a weight factor for adjusting a correction of the main focus signal by the satellite signal, filtering means coupled to the focus error signal for generating the focus actuator signal, the method comprising the step of setting the weight factor in dependence of an adjustment signal.

In optical drives, the focus control performance is often degraded by radial crosstalk. A focus actuator signal drives a focus actuator, e.g. a focus coil, and is generated based on a focus error signal, which contains crosstalk from radial error signals. In particular during crossing of tracks, e.g. during a jump when the scanning beam is moved in radial direction to access a different track, radial error signals have a periodic nature which affect the focus error signals due to crosstalk.

A device and method for scanning an optical record carrier and determining focus control signals while reducing crosstalk are known from the document WO 2004/102546. It is described that in drives for optical storage media, a focus error signal, which is produced by a weighted addition consisting of primary (main) and secondary (satellite) beam focus error signals, always contains an undesired proportion of track error signals when the weighting factors are not exactly matched to the optical and mechanical properties of the concretely existing drive and storage medium. The document describes methods for automatically matching the weighting factors to these properties. The methods are suited for use directly after inserting the storage medium, or may be used in an interruption-free manner also during the writing or reading operation.

Although the known system adjusts the weighting factors to actual device and record carrier parameters, the matching appears to be not optimal in view of suppressing residual crosstalk from radial errors to the focus error signal.

Therefore it is an object of the invention to provide a device and method for generating a reliable focus error signal in which radial crosstalk is suppressed.

According to a first aspect of the invention the object is achieved with a device as described in the opening paragraph, the setting means being arranged for generating the adjustment signal based on the focus actuator signal.

According to a second aspect of the invention the object is achieved with a method as described in the opening paragraph, which method comprises the step of generating the adjustment signal based on the focus actuator signal.

The effect of the measures is that the adjustment signal is derived based on signals after the filtering operation of the focus control system. In particular the adjustment signal is directly based on the focus actuator signal that drives the focus actuator. Advantageously the residual focus actuator signal due to radial crosstalk is minimized, reducing unnecessary forces on and dissipation in the actuator of the focus control system.

The invention is also based on the following recognition. The radial error signals, usually so-called push-pull signals, are based on signals from sub-detectors which, with respect to the reflected radiation, are displaced transverse to the longitudinal direction of the track. During crossing tracks, i.e. when the radial tracking servo loop is open, a track crossing and/or track count signal may be derived from the push-pull signals. However, during such crossing the focus servo system must be operational, and hence requires a reliable focus error signal. The crosstalk of the radial signals causes additional, unwanted focus actuator signals. The inventors have seen that, in particular during track crossing, frequency components in the radial signals may be in the operational frequency band of the focus servo. Due to the filtering in the focus servo loop, such frequencies are amplified and passed to focus actuator. In particular near the cut-off frequency of the filtering circuits, gain thereof may peak, and thereby crosstalk is amplified. This may even lead to saturation of drive circuits that generate the actuator signal. The focus servo loop may loose accuracy, or may fail altogether. Furthermore, due to large actuator control signals, a lot of unnecessary dissipation in the focus actuator may occur, which is detrimental to the power consumption, and may cause unwanted heat and, in worst case, may damage the focus actuator or its driver circuit. It is noted that the weight factor is applied to combine the main focus signal with satellite signals to reduce the crosstalk. The prior art document WO 2004/102546 discussed above adjusts the weighting factors based on an adjustment signal from the focus error signal itself, i.e. minimizing the focus error signals as is customary in servo control loops. On the contrary, the inventors have recognized that one should minimize the disturbance of the actuator due to crosstalk. It is noted that such approach may even cause larger residual focus errors, but advantageously minimizes the troubles and non-linearities at the actuator. Thereto the actuator control signal, i.e. after filtering, is used in the current invention as a source for deriving the adjustment signal, which is to be minimized by adjusting the weight factor(s).

In an embodiment of the device the detector has first satellite sub-detectors for detecting a first satellite signal from a first satellite spot and second satellite sub-detectors for detecting a second satellite signal from a second satellite spot, and the combining means are arranged for generating the focus error signal based on the main focus signal, the first satellite signal and the second satellite signal in dependence on at least one weight factor for adjusting a correction of the main focus signal by the satellite signals. Both satellite signals have a push-pull component that is mainly out of phase with the main focus signal. Advantageously the crosstalk is reduced by combining both satellite signals and applying the weight factor to adjust the correction by the out-of-phase components.

In an embodiment of the device the setting means are arranged for generating the adjustment signal in dependence of dissipation in the focus actuator due to the focus actuator signal. Advantageously the dissipation itself, which causes unwanted power consumption, is reduced by minimizing the adjustment signal based on the actuator's driving signal, i.e. the focus actuator signal. In particular, the setting means may be arranged for determining a square value of a sample of the focus actuator signal, and the dissipation is determined based on combining a number of the square values. This gives an accurate indication of the dissipation.

In an embodiment of the device the setting means are arranged for performing a calibration of the weight factor using a memory value, the memory value being a value for the weight factor stored during manufacture or during a previous calibration of the device. The calibration may be performed by initially setting the weight factor at the memory value, and subsequently varying the weight factor. Advantageously an improved weight factor can be found easily when starting from the memory value determined in an earlier calibration.

Further preferred embodiments of the device and method according to the invention are given in the appended claims, disclosure of which is incorporated herein by reference.

These and other aspects of the invention will be apparent from and elucidated further with reference to the embodiments described by way of example in the following description and with reference to the accompanying drawings, in which

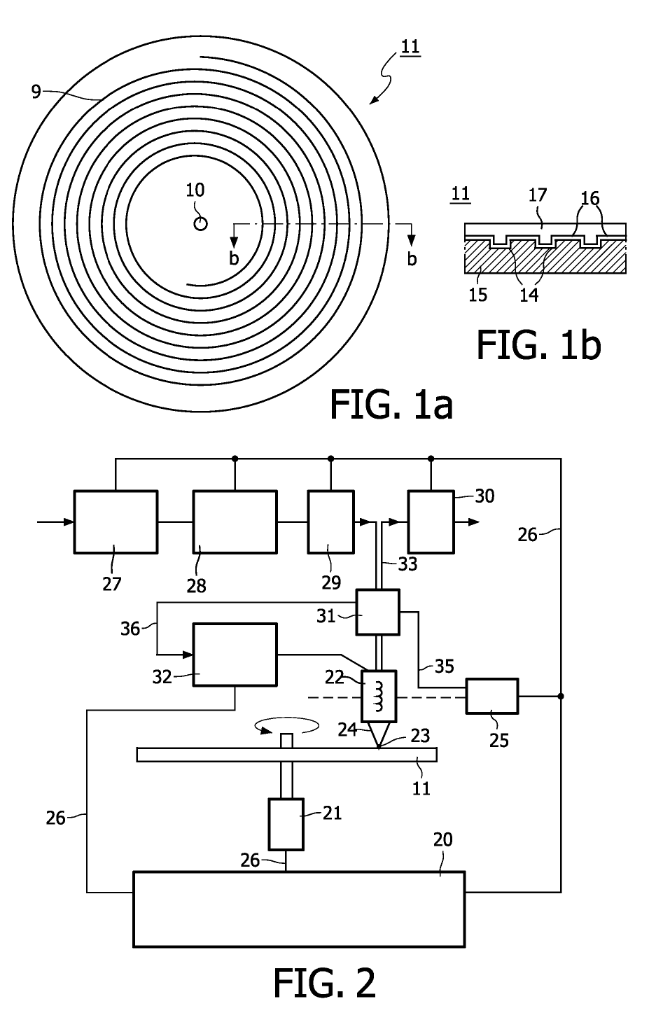

FIG. 1a shows a disc-shaped record carrier,

FIG. 1b shows a cross-section taken of the record carrier,

FIG. 2 shows a scanning device having focus crosstalk cancellation,

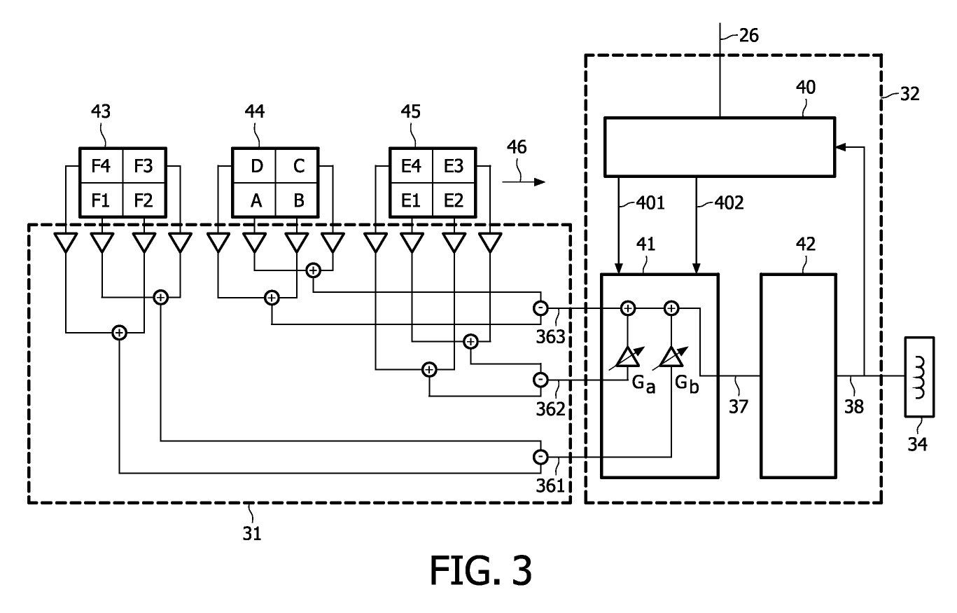

FIG. 3 shows generating and processing a focus signal,

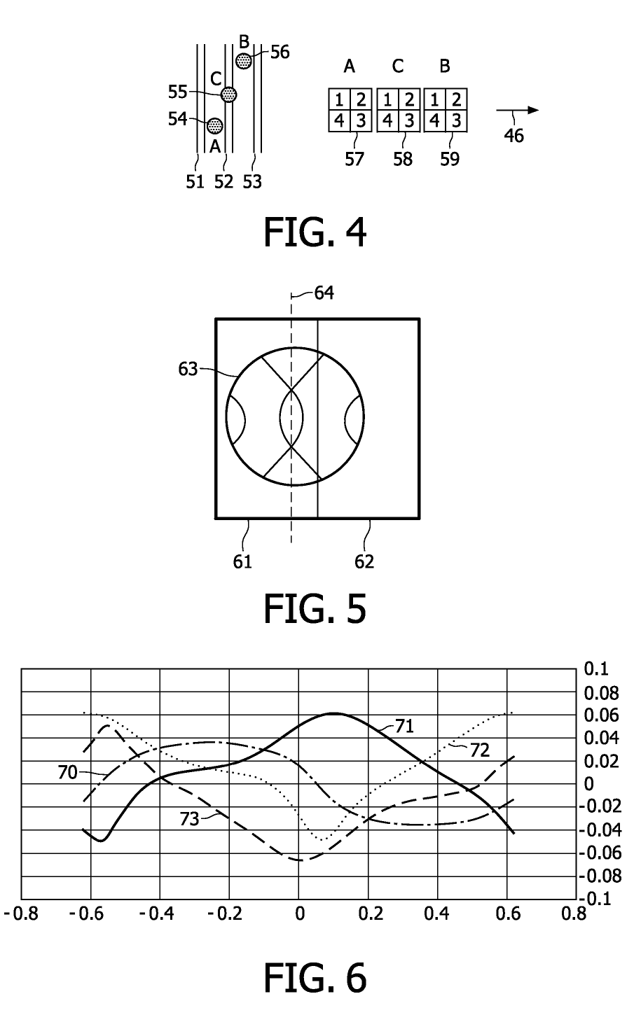

FIG. 4 shows main and satellite spots and corresponding subdetectors,

FIG. 5 shows first-diffracted radial orders that overlap, and

FIG. 6 shows the simulated focus error signal for different values of the beamlanding error.

In the Figures, elements which correspond to elements already described have the same reference numerals.

FIG. 1a shows a disc-shaped record carrier 11 having a track 9 and a central hole 10. The track 9 is arranged in accordance with a spiral pattern of turns constituting substantially parallel tracks on a data layer. The record carrier may be an optical disc having one or more data layers of a recordable type, or a ROM disk. Examples of a recordable disc are the CD-R and CD-RW, and the DVD+RW. The track 9 on the recordable type of record carrier is indicated by a pre-embossed track structure provided during manufacture of the blank record carrier, for example a pregroove. Recorded information is represented on the data layer by optically detectable marks recorded along the track. The marks are constituted by variations of a first physical parameter and thereby have different optical properties than their surroundings, e.g. variations in reflection.

FIG. 1b is a cross-section taken along the line b-b of the record carrier 11 of the recordable type, in which a transparent substrate 15 is provided with a recording layer 16 and a protective layer 17. The track structure is constituted, for example, by a pregroove 14 which enables a read/write head to follow the track 9 during scanning. The pregroove 14 may be implemented as an indentation or an elevation, or may consist of a material having a different optical property than the material of the pregroove. The pregroove enables a read/write head to follow the track 9 during scanning. A track structure may also be formed by regularly spread sub-tracks which periodically cause servo signals to occur. The record carrier may be intended to carry real-time information, for example video or audio information, or other information, such as computer data.

User data can be recorded on the record carrier by marks having discrete lengths in unit called channel bits, for example according to the CD or DVD channel coding scheme. The marks are having lengths corresponding to an integer number of channel bit lengths T. The shortest marks that are used have a length of a predefined minimum number d of channel bit lengths T for being detectable via the scanning spot on the track that has an effective diameter, usually being roughly equal to the length of the shortest mark.

FIG. 2 shows a scanning device having focus crosstalk cancellation. The device is provided with means for scanning a track on a record carrier 11 which means include a drive unit 21 for rotating the record carrier 11, a head 22, a servo unit 25 for positioning the head 22 on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises a focus actuator 34 for moving the focus of the radiation beam 24 along the optical axis of said beam and a tracking actuator (not shown) for fine positioning of the spot 23 in a radial direction on the center of the track. The tracking actuator may comprise coils for radially moving an optical element or may alternatively be arranged for changing the angle of a reflecting element. The tracking actuators are driven by actuator signals from the servo unit 25. The focus actuator 34 is driven by a focus actuator signal from focus control unit 32.

For reading the radiation reflected by the data layer is detected by a detector of a usual type, e.g. a four-quadrant diode, in the head 22 for generating detector signals coupled to a front-end unit 31 for generating various scanning signals, including a main scanning signal 33 and radial error signals 35 for tracking. The main scanning signal 33 is processed by read processing unit 30 of a usual type including a demodulator, deformatter and output unit to retrieve the information. The radial error signals 35 are coupled to the servo unit 25 for controlling said tracking actuators. The front-end unit further provides sub-detector signals 36 coupled to the focus control unit 32 to be processed into the focus actuator signal according to the invention as described below in detail.

The control unit 20 controls the scanning and retrieving of information and may be arranged for receiving commands from a user or from a host computer. The control unit 20 is connected via control lines 26, e.g. a system bus, to the other units in the device. The control unit 20 comprises control circuitry, for example a microprocessor, a program memory and interfaces for performing the procedures and functions as described below. The control unit 20 may also be implemented as a state machine in logic circuits. It is noted that the focus adjustment functions as described below may also be implemented as software functions in the control unit 20. The control unit 20 communicates with the focus control unit 32 and other units for performing a focus adjustment functions as discussed in detail below.

In an embodiment the device is provided with recording means for recording information on a record carrier of a writable or re-writable type, for example CD-R or CD-RW, or DVD+RW or BD. The recording means cooperate with the head 22 and front-end unit 31 for generating a write beam of radiation, and comprise write processing means for processing the input information to generate a write signal to drive the head 22, which write processing means comprise an input unit 27, a formatter 28 and a modulator 29. For writing information the beam of radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of polarization different from their surroundings, obtained when recording in magneto-optical material.

In an embodiment the input unit 27 comprises compression means for input signals such as analog audio and/or video, or digital uncompressed audio/video. Suitable compression means are described for video in the MPEG standards, MPEG-1 is defined in ISO/IEC 11172 and MPEG-2 is defined in ISO/IEC 13818. The input signal may alternatively be already encoded according to such standards.

In an embodiment the recording device is a storage system only, e.g. an optical disc drive for use in a computer. The control unit 20 is arranged to communicate with a processing unit in the host computer system via a standardized interface. Digital data is interfaced to the formatter 28 and the read processing unit 30 directly.

In an embodiment the device is arranged as a stand alone unit, for example a video recording apparatus for consumer use. The control unit 20, or an additional host control unit included in the device, is arranged to be controlled directly by the user, e.g. to perform the functions of a file management system.

FIG. 3 shows generating and processing a focus signal. A multi-segment detector is shown as main subdetectors 44 marked A,B,C,D in a position for receiving radiation reflected from a central spot to be positioned on a track on the data layer of a record carrier, a first set of satellite subdetectors 45 marked E1,E2,E3,E4 and a second set of satellite subdetectors 43 marked F1,F2,F3,F4, the satellite subdetectors being in a position for receiving radiation reflected from satellite spots that are displaced in a transverse direction with respect to the longitudinal direction of the track which direction is indicated by an arrow 46. The subdetectors are arranged in quadrants aligned in a direction corresponding to the track direction.

FIG. 4 shows main and satellite spots and corresponding subdetectors. The Figure shows schematically a part of a data layer of a record carrier having three parallel tracks 51,52,53. A main spot 55 is centered on a scanned track 52, a first satellite spot 54 is positioned radially displaced to the left in between the scanned track 52 and a neighboring track 51, whereas a second satellite spot 56 is positioned in between the scanned track 52 and a neighboring track 53, i.e. radially displaced to the right, opposite to the first satellite spot. Three sets of subdetectors are shown, main subdetectors 58 correspond to the central spot 55 on the track, first satellite subdetectors 57 correspond to the first satellite spot 54, and second satellite subdetectors 59 correspond to the second satellite spot 56.

FIG. 3 further shows circuitry for processing signals from the subdetectors to a focus actuator signal 38 that drives the focus actuator 34, for example a coil. The signals from each subdetector are amplified and added in the front-end unit 31 (shown by a dashed line) for generating a central focus error signal (FESc) 363 from the main subdetectors 44 as follows:

FESc=(A+C)−(D+B)

and a first satellite error signal (FESa) 362 as follows:

FESa=(E1+E3)−(E2+E4)

and a second satellite error signal (FESb) 361 as follows:

FESb=(F1+F3)−(F2+F4)

Similar formulas can be derived for the numbered subdetectors in FIG. 4. The error signals 361,362,363 are coupled to the focus control unit 32, which comprises a combining unit 41, a servo control unit 42 and a setting unit 40.

The combining unit 41 adds to the central focus error signal (FESc) 363 the first satellite error signal (FESa) 362 adjusted by a first weight factor Ga, and the second satellite error signal (FESb) 361 adjusted by a second weight factor Gb, as follows:

FES=FESc+Ga×FESa+Gb×FESb

wherein FES is the focus error signal 37 after compensation for radial crosstalk, as explained below. The focus error signal 37 is subsequently filtered in servo control unit 42, which filters the focus error signal 37, applies a focus set point and generates the focus actuator signal 38 constituting a servo control system, according to focus servo control rules well known as such.

The setting unit 40 receives the focus actuator signal 38, and derives a first setting signal 401 for setting the first weight factor Ga, and a second setting signal 402 for setting the second weight factor Gb. The setting unit sets the weight factors in dependence of an adjustment signal that is based on the focus actuator signal 38. The generated power in the focus actuator is reduced by monitoring the focus actuator signal 38. The setting means may be arranged for generating an adjustment signal in dependence of dissipation in the focus actuator due to the focus actuator signal. For example, a square value of samples of the focus actuator signal may be determined. The dissipation may be determined based on combining a number of the square values, e.g. during a measurement period of crossing tracks.

The setting unit 40 may be coupled to the control unit 20 via control lines 26 for performing a calibration for the adjustment of the weight factors under the control of the system control unit 20. For example, the system control may perform a calibration when a record carrier is inserted in the scanning device. The setting unit operates as follows for canceling radial-to-focus crosstalk. It is noted that the function of the setting unit may alternatively be performed as a method of setting the weight factors in a separate processing unit, e.g. in the main control unit 20.

The method for canceling radial-to-focus crosstalk as described now uses a 12-segment photodetector as shown in FIGS. 3 and 4. The canceling method is usually combined with the 3-spot Push Pull method (called differential push-pull DPP based on PP signals) for tracking. However it is to be noted that different types of tracking and detectors may be used also, if at least one set of satellite subdetectors is available for generating a satellite signal that has a radial component opposite to the radial component in the central focus error signal.

It is noted that the invention is particularly useful when the focus servo loop is operational, and the radial tracking is disabled. In such situations there is a significant amount of radial error signals that may disturb the focus servo loop due to crosstalk. For example, when a jump is performed in radial direction for accessing a different track, the intermediate tracks need to be counted. Tracks counting signals may be based on the radial tracking error signals. In practice during track counting the radial error signals may vary at around 10 kHz, which is in the active frequency range of the focus servo. In particular at such frequencies the filtering of the focus servo loop may have a cut-off, and gain may peak. Hence such disturbances due to crosstalk may cause strong components in the focus actuator signal, which hardly result in any effective movement of the actuator, but cause a lot of unwanted power dissipation. During the radial movement, the spots need to remain focused on the data layer of the record carrier. However, it is noted that the cancellation system may be used in any operational mode.

When the radial servo loop is disabled, for example when the device is in seek mode, the spots will cross the tracks and generate PP signals in each of the spots. The PP of the central spot will leak into the focus error signal FES, which causes a disturbance that can be so large that an unacceptable dissipation in the focus coil results, or causes the focus driver to saturate against the supply rail. The result might be that the system cannot reliably maintain focus when it's in open radial loop mode. The 12-segment canceling method solves this problem by using a combination of three focus error signals, obtained from each of the spots as described above. Note that in the formula FEAa, FESb and FESc correspond to focus error signals from the spots A, B and C in FIG. 4, and Ga and Gb are appropriate weighting factors that minimize the resulting PP crosstalk in FES. Because the PP of the satellites have mainly an opposite phase with respect to the PP of the central beam, the combined focus error signal FES can be made free of PP crosstalk.

In practice, especially so-called land-groove formats such as DVD-RAM and HD-DVD−RW require this form of crosstalk canceling, because they have a large PP due to the relative large groove pitch, which is twice the data pitch.

Theoretically, when the alignment of the system is perfect and the satellite spots A and B are exactly halfway on the adjacent tracks, and the 3 returning beams are perfectly centered on their quad detectors, the optimum value of Ga and Gb is given by

Ga=Gb=G/2

where G is the intensity ratio of the central and the satellite beams. In this case the radial crosstalk cancellation is perfect, i.e. no residual PP is left in FES.

In practice there are several circumstances that jeopardize this simple optimization scheme. First, the intensity ratio G may have a significant spread from one optical pickup unit (OPU) in the head 22 to the next, which makes an adjustment per OPU necessary. Another complication is that the satellite spots are generally not exactly located halfway between the tracks. This may be caused by an adjustment error of the grating that is used to generate the satellites, or by a so-called y-error, which causes the angle between the 3 spots and the tangent to the tracks to vary with the readout radius. Moreover, the eccentricity of the disk and the spindle motor will cause this angle to vary during one revolution of the disk. This varying angle will cause the residual PP disturbance in FES to vary as well, i.e. the envelope of the disturbance will in general vary with the radius and the azimuth of the readout spot. A further serious complication is that, when crossing tracks, the crosstalk in FES on e.g. DVD-RAM is in general far from sinusoidal, and heavily depends on the beamlanding error. This is due to the fact that the large groove pitch of DVD-RAM causes the first-diffracted radial orders to overlap, and that the second-diffracted radial orders enter the pupil.

FIG. 5 shows first-diffracted radial orders that overlap. A detector has a left half subdetector 61 and a right half subdetector 62. A spot 63 is shown to arrive mainly on the left half 61, whereas the actual center line 64 indicates the center of the beam. The difference of the center line 64 and the center position on the detector is called beamlanding error. In the spot 63 the first-diffracted radial orders that overlap are indicated.

In the case of a beamlanding error the overlap area will be located entirely on one detector half, which influences the shape of the resulting crosstalk signal. The beamlanding error of the two satellite beams can be different, due to a combination of a positional error of the complete detector, and an error in distance between the two satellites (a so-called grating-z error).

FIG. 6 shows the simulated focus error signal for different values of the beamlanding error. The horizontal axis shows the radial position of the main spot with respect to a track, in μm in radial distance. The vertical axis shows the focus error signal FES derived from the central spot 55 (“C” in FIG. 4), and normalized to a standard range. A first curve 70 shows the ideal situation at no beamlanding error. A second curve 71 shows a focus error signal, with a position error of +10 μm in the radial direction, and +10 μm in the tangential direction. A third curve 72 shows a focus error signal, with a position error of −10 μm in the radial direction, and −10 μm in the tangential direction. A fourth curve 73 shows a focus error signal, with a position error of +10 μm in the radial direction, and −10 μm in the tangential direction. We see large variations in the shape of the residual crosstalk when the beamlanding error varies. Hence the residual crosstalk signal in FES is non-sinusoidal, and its amplitude varies along the radius and during the revolution of the disk. This makes setting an optimum value of Ga and Gb difficult. The following provides a calibration method that finds the optimum value of Ga and Gb for a specific situation, i.e. the combination of a specific disk and a specific OPU.

The proposed calibration method is based on minimizing the power dissipation in the focus coil. This criterion is particularly useful because dissipation is the main problem that is caused by the radial crosstalk into the focus error signal FES. By comparing the average dissipation during identical open-loop modes—e.g. averaged during one disk revolution—between different settings of Ga and Gb, an optimum value can be found. A measurement for adjusting the weight factors may be performed at any time that the head 22 crosses tracks.

During startup of the drive with a particular disk a calibration can be done as follows:

1. Acquire focus using default values of Ga and Gb, e.g. values that were determined during manufacturing of the drive, or values that were obtained from a previous calibration and stored in a memory, like an EEPROM.
2. Measure the power dissipation in the focus coil, e.g. by taking the square of the output samples of the focus actuator signal produced by the digital focus servo and average them (or just do a summation) during an appropriate time period. This time period might be one disk revolution, or the duration of one or more seeks that are done for the purpose of calibration. It is noted that a less accurate indication of the unwanted control energy in the focus actuator may also be use, e.g. just taking the absolute values of the focus actuator signal, or by taking the peak value.
3. Repeat this measurement, stepping through an appropriate range of Ga and Gb, simultaneously varying both parameters with the same relative step.
4. Repeat the measurement, stepping through an appropriate (small) range of Ga and Gb, varying both parameters with an opposite relative step.
5. Find the values of Ga and Gb for which the power dissipation in the focus coil is minimum. These values are used for al subsequent operations on that disk, and might be stored in a memory for later use.

In an embodiment only a single value for a weight factor may be determined, or both weight factors may be adjusted to the same value. Different values for Ga and Gb may not be available, e.g. due to the way the signal processing in the further circuits is arranged, or due to the arrangement of the analog front-end unit. In that case step 4 is omitted.

Although the invention is generally applicable in drives that use the 12-segment cancellation method, other detectors and cancellation arrangements may be used. It is particularly useful on media that have high radial error signal values, such as the land-groove formats DVD-RAM and HD-DVD−RW, or the so-called Low-to-High BD-R media, and also for media having dual or multiple data layers, so called multi-layer record carriers. The invention is also suitable for other record carriers such as rectangular optical cards, magneto-optical discs, multilayer high-density discs or any other type of information storage system that has a focus system sensitive to radial crosstalk.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the invention is not limited to the embodiments, and lies in each and every novel feature or combination of features described above.

1. Device for scanning an optical record carrier (11), the record carrier comprising a data layer having substantially parallel data tracks, the device comprising
an optical head (22) comprising a detector for receiving radiation reflected from the data layer, the detector having main sub-detectors for detecting a main focus signal from a main spot and satellite sub-detectors for detecting a satellite signal from a satellite spot,
focus control means (32) for providing a focus actuator signal to a focus actuator in dependence of a focus error signal, the focus control means comprising
combining means (41) for generating the focus error signal based on the main focus signal and the satellite signal in dependence on a weight factor for adjusting a correction of the main focus signal by the satellite signal,
filtering means (42) coupled to the focus error signal for generating the focus actuator signal, and
setting means (40) for setting the weight factor in dependence of an adjustment signal,
the setting means (40) being arranged for generating the adjustment signal based on the focus actuator signal.

2. Device as claimed in claim 1, wherein the detector has first satellite sub-detectors (45) for detecting a first satellite signal from a first satellite spot and second satellite sub-detectors (43) for detecting a second satellite signal from a second satellite spot, and the combining means (41) are arranged for generating the focus error signal (37) based on the main focus signal (363), the first satellite signal (362) and the second satellite signal (361) in dependence on at least one weight factor for adjusting a correction of the main focus signal by the satellite signals.

3. Device as claimed in claim 1, wherein the main sub-detectors (44) and satellite sub-detectors (43,45) are arranged in quadrants aligned in a direction corresponding to the track direction (46).

4. Device as claimed in claim 1, wherein the setting means (40) are arranged for generating the adjustment signal in dependence of dissipation in the focus actuator due to the focus actuator signal (38).

5. Device as claimed in claim 4, wherein the setting means (40) are arranged for determining a square value of a sample of the focus actuator signal, and the dissipation is determined based on combining a number of the square values.

6. Device as claimed in claim 1, wherein the setting means (40) are arranged for performing a calibration of the weight factor using a memory value, the memory value being a value for the weight factor stored during manufacture or during a previous calibration of the device.

7. Device as claimed in claim 2, wherein the combining means (41) are arranged for applying a first weight factor for the first satellite signal and a second weight factor the second satellite signal, and the setting means (40) are arranged for performing a calibration of the weight factors by varying both weight factors with a step in a same direction

8. Device as claimed in claim 7, wherein the setting means (40) are arranged for performing the calibration by varying both weight factors with a step in opposite directions.

9. Method of setting a weight factor in a device for scanning an optical record carrier, the record carrier comprising a data layer having substantially parallel data tracks, the device comprising
an optical head (22) comprising a detector for receiving radiation reflected from the data layer, the detector having main sub-detectors for detecting a main focus signal from a main spot and satellite sub-detectors for detecting a satellite signal from a satellite spot,
focus control means (32) for providing a focus actuator signal to a focus actuator in dependence of a focus error signal, the focus control means comprising
combining means (41) for generating the focus error signal based on the main focus signal and the satellite signal in dependence on a weight factor for adjusting a correction of the main focus signal by the satellite signal,
filtering means (42) coupled to the focus error signal for generating the focus actuator signal,
the method comprising the steps of
setting the weight factor in dependence of an adjustment signal, and
generating the adjustment signal based on the focus actuator signal.

10. Method as claimed in claim 9, wherein in the device the combining means (41) are arranged for applying a first weight factor for the first satellite signal and a second weight factor the second satellite signal, and the method comprises a step of performing a calibration, the calibration comprising at least one of
varying both weight factors with a step in a same direction;
varying both weight factors with a step in opposite directions.
